(19) United States
(12) Patent Application Publication
(10) Pub. No.: US 2006/0132648 A1
(43) Pub. Date: Jun. 22, 2006

(54) Apparatus to enhance image signal distinction and method thereof

(76) Inventors: Yeo-jin Kang, Suwon-si (KR); Young-jin Kwon, Seongnam-si (KR)

Correspondence Address: Stanzione & Kim, LLP, Suite 440, 919 18th Street, NW, Washington, DC, 20006, US

(21) Appl. No.: 11/294,498

(22) Filed: Dec. 6, 2005

(30) Foreign Application Priority Data
Dec. 21, 2004 (KR) 2004-109405

(51) Int. Cl. H04N 7/01; H04N 11/20

(52) U.S. Cl. 348/448; 348/441

(57) ABSTRACT

An apparatus to enhance a distinction of image signals and a method thereof. The apparatus includes a de-interlacing unit to de-interlace input image signals using an interlaced scanning method and to output a de-interlaced image signal using a progressive scanning method, and a saw-tooth artifact processor to remove saw-tooth artifacts based on a diffusion value and a median value of the de-interlaced image signal, the artifacts being included in the de-interlaced image signal. The saw-tooth artifacts generated when neighboring pixels have a small difference are removed, and, at the same time, the detailed components of an image are represented effectively without being lost.

### CROSS-REFERENCE TO RELATED APPLICATIONS

This application claims the benefit under 35 U.S.C. § 119 from Korean Patent Application No. 2004-109405, filed in the Korean Intellectual Property Office on Dec. 21, 2004, the entire content of which is incorporated herein by reference.

### BACKGROUND OF THE INVENTION

1. Field of the Invention

The present general inventive concept relates to an apparatus to enhance distinction of image signals and a method thereof. More specifically, the present general inventive concept relates to an apparatus and a method of removing saw-tooth artifacts included in de-interlaced image signals to enhance distinction of the image signals.

2. Description of the Related Art

An interlaced scanning method and a progressive scanning method are used as scanning methods of an image display apparatus. The interlaced scanning method is used in TVs and the like. In the interlaced scanning method, when an image is displayed, one image frame is divided into two fields, and displayed sequentially and alternatively on a screen. Here, the two fields of the image are called a top field and a bottom field, an upper field and a lower field, an odd field and an even field, etc.

The progressive scanning method (or the non-interlaced scanning method) is used in computer monitors, digital TV's, etc., to display a whole frame at once using one image frame as a frame unit in a manner similar to the manner in which a film is projected on a screen.

A de-interlacing device is a device for converting first image signals using the interlaced scanning method into second image signals using the progressive scanning method. A display device, such as a digital TV, that processes second image signals using the progressive scanning method needs the de-interlacing device for converting the first image signals using the interlaced scanning method into the second image signals using the progressive scanning method in order to display an image based on the interlaced input image signals.

The following methods are de-interlacing methods of converting the first image signals using the interlaced scanning method into the second image signals using the progressive scanning method. Generally, a line repeating method has been used as the de-interlacing method to simply repeat line information of a current field. In addition, there are an intra-field interpolation method and an inter-field interpolation method. The intra-field interpolation method implements a new data line using data of two lines into an area between the two lines of the current field. The inter-field interpolation method implements one image from two fields by inserting previous and next lines of adjacent fields into an area between the lines of the current field. The inter-field interpolation method does not compensate for motion.

Therefore, when the de-interlacing method is improperly performed, saw-tooth artifacts are generated at an edge or an area with moving features of an image. A saw-tooth artifact is a phenomenon in which a difference between a scanning line and an interlaced signal line is visible. The scanning line is interpolated through the de-interlacing methods between two neighboring horizontal scanning lines having similar characteristics. When enhancing a distinction of an image having such saw-tooth artifacts, the saw-tooth artifacts are greatly highlighted and unpleasant to the eyes.

In U.S. Pat. No. 5,625,421, an apparatus for suppressing saw-tooth artifacts is disclosed. FIG. 1 is a block diagram illustrating a configuration of a conventional apparatus for suppressing saw-tooth artifacts.

Referring to FIG. 1, a saw-tooth artifact detector 10 detects an area where the saw-tooth artifacts have occurred, that is, an area where two consecutive horizontal scanning lines of a de-interlaced image signal have a big difference and two horizontal scanning lines skipping a line therebetween have a small difference. A vertical averaging unit 20 removes the saw-tooth artifacts by performing a filtering process in a vertical direction with respect to the area where the saw-tooth artifacts have occurred, and thus an image becomes blurred.

However, in U.S. Pat. No. 5,625,421, a difference between the scanning lines is judged by comparing the difference to threshold values. When using the threshold values, there may be an error in determining the area where the saw-tooth artifacts have occurred. In addition, the filtering process is performed in the vertical direction in the area where artifacts have occurred, and thus, the artifacts are not completely suppressed, thereby degrading an image quality.

### SUMMARY OF THE INVENTION

The present general inventive concept provides an apparatus for enhancing to enhance distinction of image signals and a method thereof, in which saw-tooth artifacts included in de-interlaced image signals are effectively removed, and, at the same time, detailed components of an image can be represented correctly without loss.

Additional aspects and advantages of the present general inventive concept will be set forth in part in the description which follows and, in part, will be obvious from the description, or may be learned by practice of the general inventive concept.

The foregoing and/or other aspects of the present general inventive concept may be achieved by providing an apparatus to remove saw-tooth artifacts from a de-interlaced image signal, the apparatus comprising a de-interlacing unit to de-interlace input image signals using an interlaced scanning method and to output a de-interlaced image signal using the progressive scanning method, and a saw-tooth artifact processor to remove saw-tooth artifacts based on a diffusion value and a median value of the de-interlaced image signal, the saw-tooth artifacts being included in the de-interlaced image signal.

The saw-tooth artifact processor may include a diffusion value calculator to calculate the diffusion value based on a similarity of the de-interlaced image signal, a median value calculator to calculate the median value based on a magnitude of the de-interlaced image signal, and a selector to compare a pixel value of a current pixel included in a current line of the de-interlaced image signal with pixel values of pixels neighboring the current pixel, and removing the saw-tooth artifacts by selectively outputting the diffusion value and the median value according to the comparison.

The diffusion value calculator may judge whether the pixels neighboring the current pixel are similar when a pixel difference of the pixel values of the pixels neighboring the current pixel in the de-interlaced image signal is smaller than a predetermined threshold value, and calculates the diffusion value by performing low-pass filtering on the current pixel value and the pixel values of the pixels neighboring the current pixel.

When pixel difference of the pixel values of the pixels neighboring the current pixel in the de-interlaced image signal is greater than a predetermined threshold value, the diffusion value calculator may output the de-interlaced image signal received from the de-interlacing unit as is.

The neighbor pixels comprise a previous pixel and a next pixel of a previous line and a next line of the current line respectively, and the median value calculator may calculate the median value by comparing the pixel value of the current pixel included in the current line of the de-interlaced image signal with the pixel values of the previous pixel and the next pixel, the previous pixel being included in the previous line and located above the current pixel, the next pixel being included in the next line and located below the current pixel.

When the pixel value of the current pixel is the median value of the pixel values of the pixels neighboring the current pixel, the selector may output the de-interlaced input image signal as is.

Here, when the pixel value of the current pixel is a maximum value of the pixel values of the pixels neighboring the current pixel, the selector may output a greater one of the diffusion value and the median value received from the diffusion value calculator and the median value calculator respectively.

Here, when the pixel value of the current pixel is a minimum value the pixel values of the pixels neighboring the current pixel, the selector may output a smaller value of the diffusion value and the median value received from the diffusion value calculator and the median value calculator respectively.

The foregoing and/or other aspects of the present general inventive concept may also be achieved by providing a method of removing saw-tooth artifacts from a de-interlaced image signal, the method including de-interlacing input image signals using an interlaced scanning method and outputting a de-interlaced image signal using the progressive scanning method, and processing saw-tooth artifacts in order to remove the saw-tooth artifacts based on a diffusion value and a median value of the de-interlaced image signal, the saw-tooth artifacts being included in the de-interlaced image signal.

The processing of the saw-tooth artifacts may include calculating the diffusion value based on a similarity of the de-interlaced input image signal, and calculating the median value based on a magnitude of the de-interlaced input image signal, and comparing a pixel value of a current pixel included in a current line of the de-interlaced image signal with pixel values of pixels neighboring the current pixel, and removing the saw-tooth artifacts by selectively outputting the diffusion value and the median value according to the comparison.

When a pixel difference of the pixel values of the pixels neighboring the current pixel in the de-interlaced image signal is smaller than a predetermined threshold value, a diffusion value may be calculated by performing low-pass filtering on the pixel values.

The comparing of the pixel value and removing of the saw-tooth artifacts, comprises when the pixel value of the current pixel is substantially equal to the median value pixels neighboring the current pixel, outputting the de-interlaced image signal as is.

The comparing of the pixel value and removing of the saw-tooth artifacts, comprises when the pixel value of the current pixel is a maximum value of pixels neighboring the current pixel, outputting a greater one value of the received median value and the diffusion value.

The comparing of the pixel value and removing of the saw-tooth artifacts, comprises when the pixel value of the current pixel is a minimum value of pixels neighboring the current pixel, outputting a smaller one of the received median value and the diffusion value.

The foregoing and/or other aspects of the present general inventive concept may also be achieved by providing an apparatus to remove saw-tooth artifacts from a de-interlaced image signal, the apparatus including a calculating unit to calculate a diffusion value and a median value using a pixel value of a current pixel, and pixel values of pixels neighboring the current pixel, and a selector to output one of the pixel value of the current pixel, the diffusion value and the median value according to a first comparison of the pixel value of the current pixel with the pixel values of the pixels neighboring the current pixel, and a second comparison of the diffusion value and the median value.

The foregoing and/or other aspects of the present general inventive concept may also be achieved by providing a method of removing saw-tooth artifacts from a de-interlaced image signal including a plurality of pixel values, the method including calculating a diffusion value and a median value using a pixel value of a current pixel, and pixel values of pixels neighboring the current pixel, and outputting one of the pixel value of the current pixel, the diffusion value and the median value according to a first comparison of the pixel value of the current pixel with the pixel values of the pixels neighboring the current pixel, and a second comparison of the diffusion value and the median value.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a block diagram illustrating a conventional apparatus for removing saw-tooth artifacts;

FIG. 2 is a block diagram illustrating a configuration of an apparatus to enhance a distinction of image signals according to the present general inventive concept;

FIG. 3 is a block diagram illustrating a detailed configuration of a saw-tooth artifact processor of the apparatus of FIG. 2;

FIG. 4 is a flow chart illustrating a method of enhancing a distinction of image signals according to the present general inventive concept;

FIGS. 5A to 5C illustrate a pixel value of a current pixel having a median value, a maximum value, and a minimum value respectively; and

FIG. 6 illustrates examples of neighboring pixels having small pixel differences with respect to an image signal containing saw-tooth artifacts.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept while referring to the figures.

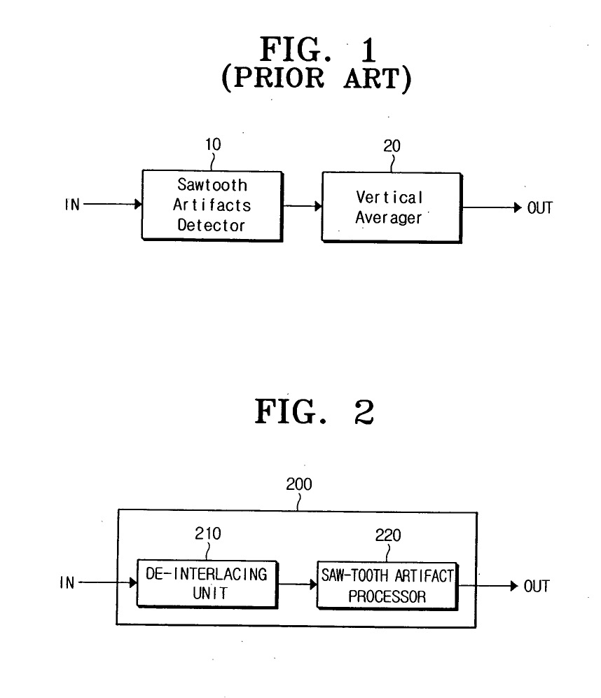

FIG. 2 is a block diagram illustrating a configuration of an apparatus 200 to enhance a distinction of image signals according to the present general inventive concept. Referring to FIG. 2, the apparatus 200 to enhance the distinction of the image signals comprises a de-interlacing unit 210 and a saw-tooth artifact processor 220. The de-interlacing unit 210 converts an input image signal using an interlaced scanning method into a de-interlaced image signal using a progressive scanning method and outputs the converted de-interlaced image signal. The saw-tooth artifact processor 220 removes saw-tooth artifacts included in the de-interlaced image signal using the progressive scanning method received from the de-interlacing unit 210.

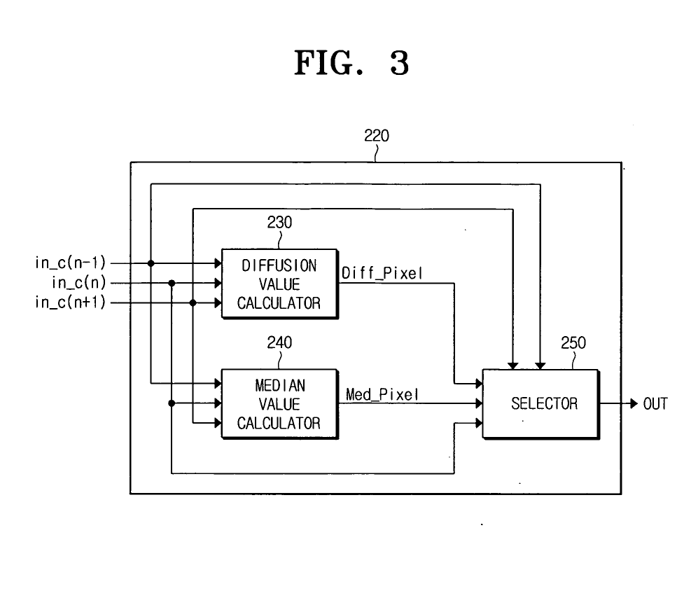

FIG. 3 illustrates a detailed configuration of the saw-tooth artifact processor 220 of the apparatus 200 of FIG. 2. Referring to FIGS. 2 and 3, the saw-tooth artifact processor 220 includes a diffusion value calculator 230, a median value calculator 240, and a selector 250. The saw-tooth artifact processor 220 receives de-interlaced image signal including a pixel value IN_C(N) of a current pixel included in a current line, a pixel value IN_C(N−1) of a previous pixel located in a previous line, and a pixel value IN_C(N+1) of a next pixel located a next line. The previous pixel and the next pixel are neighboring pixels of the current pixel.

The diffusion value calculator 230 calculates a diffusion value based on a similarity of the de-interlaced image signal. That is, the diffusion value calculator 230 judges whether the neighboring pixels are similar. The neighboring pixels are similar if a pixel difference of pixel values of the neighboring pixels in the de-interlaced image signal is smaller than a predetermined threshold value. When the neighboring pixels are judged to be similar, the diffusion value calculator 230 calculates a diffusion value DIFF_PIXEL by performing a low-pass filtering of the pixel value of the current pixel and/or the pixel values of the neighboring pixels, and the calculated diffusion value DIFF_PIXEL is provided to the selector 250.

The diffusion value calculator 230 judges that the neighboring pixels are not similar when the pixel difference of the pixel values of neighboring pixels in the input image signal is greater than the predetermined threshold value. When the neighboring pixels are judged not to be similar, the diffusion value calculator 230 does not perform the low-pass filtering, and the image signal received from the de-interlacing unit 210 is output as is. That is, the pixel value of the current pixel may be output as the diffusion value DIFF_PIXEL.

The median value calculator 240 calculates a median value MED_PIXEL based on the de-interlaced image signal received from the de-interlacing unit 210. That is, the median value calculator 240 compares the pixel value of the current pixel included in the current line of the input image signal with the pixel values of the previous pixel and the next pixel, and calculates the median value MED_PIXEL. The previous pixel may be included in the previous line and located above the current pixel, and the next pixel may be included in the next line and located below the current pixel.

The selector 250 may compare the current pixel included in the current line of the de-interlaced image signal with the upper pixel located above the current pixel and the lower pixel located below the current pixel, and determines which one of the three values has as a pixel value equal to a minimum value, a maximum value, and the median value.

As a result of this determination, when the pixel value of the current pixel is the median value MED_PIXEL of the three values, the selector 250 outputs the received pixel value of the current pixel.

However, when the pixel value of the current pixel is the maximum value of the three values, the selector 250 compares the median value MED_PIXEL and the diffusion value DIFF_PIXEL received from the median value calculator 240 and the diffusion value calculator 230 respectively, and outputs the greater value between the median value MED_PIXEL and the diffusion value DIFF_PIXEL.

Moreover, when the pixel value of the current pixel is the minimum value of the three values, the selector 250 compares the median value MED_PIXEL and the diffusion value DIFF_PIXEL received from the median value calculator 240 and the diffusion value calculator 230 respectively, and outputs the smaller value between the median value MED_PIXEL and the diffusion value DIFF_PIXEL.

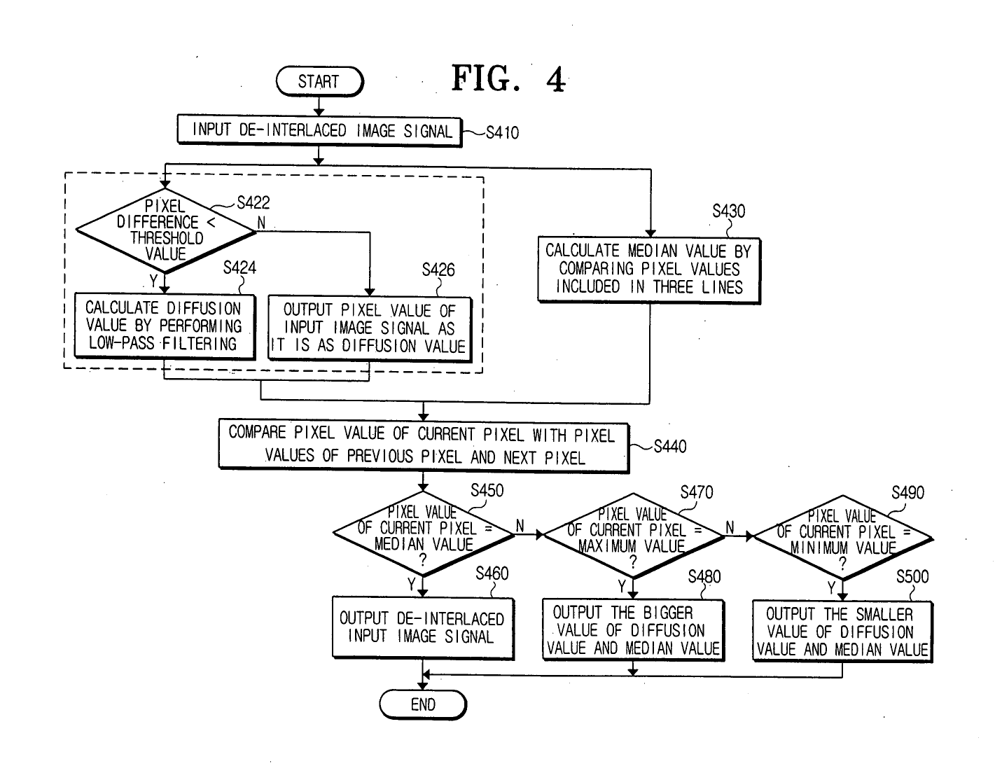

FIG. 4 is a flow chart illustrating a method of enhancing the distinction of image signals according to the present general inventive concept. Referring to FIGS. 2 to 4, first, three lines of the de-interlaced image signal received from the de-interlacing unit 210 are entered into the saw-tooth artifact processor 220 at operation S410.

The diffusion value calculator 230 of the saw-tooth artifact processor 220 compares a pixel difference between pixel values of pixels included in the image signals of the three lines, i.e. the previous line, the current line, and the next line, with a predetermined threshold value, judges whether the pixels of the three lines are similar, and calculates a diffusion value according to that judgment at operation S420.

When the pixel difference of the neighboring pixels of the three lines is smaller than a predetermined threshold value S422, the diffusion value calculator 230 judges whether the neighboring pixels of the three lines are similar, and calculates the diffusion value by performing low-pass filtering on the neighboring pixels of the three lines at operation S424. Then, the calculated diffusion value is provided to the selector 250. Generally, the saw-tooth artifacts generated during the de-interlacing process occur between the neighboring pixels having a small pixel difference, so that the saw-tooth artifacts are removed according to the diffusion value and the low-pass filtering.

However, when the pixel difference of the neighboring pixels of the three lines is greater than the predetermined threshold value at operation S422, the diffusion value calculator 230 judges that the neighboring pixels of the three lines are not similar. When the neighboring pixels of the three lines are judged not similar, the diffusion value calculator 230 does not perform the low-pass filtering and outputs the de-interlaced image signal to the selector 250 as it is at operation S426. Here, the diffusion value becomes the pixel value of the de-interlaced image signal as it is. Generally, the neighboring pixels, having such a pixel difference greater than the predetermined threshold, are detailed components of an image, so that if the low-pass filtering is performed for this image, the detailed components of the image are incorrectly represented.

The median value calculator 240 calculates the median value based on the de-interlaced image signal. That is, the median value calculator 240 calculates the median value at operation S430 by comparing the pixel values of the current pixel located in the current line of the input image signal, the previous pixel included in the previous line and located in the line above the current pixel, and the next pixel located in the next line, i.e. below the current line. This can be represented in a mathematical formula described below.
[Mathematical formula 1]
   MED_PIXEL=Med(IN_{—}C(N−1), IN_{—}C(N), IN_{—}C(N+1))

In the mathematical formula 1, Med is a function to calculate the median value, IN_C(N) represents the current pixel included in the current line, IN_C(N−1) represents the previous pixel located above the current pixel, and IN_C(N+1) represents the next pixel located below the current pixel.

The selector 250 receives the diffusion value and the median value from the diffusion value calculator 230 and the median value calculator 240 respectively, and, the de-interlaced image signal of the three lines from the de-interlacing unit 210.

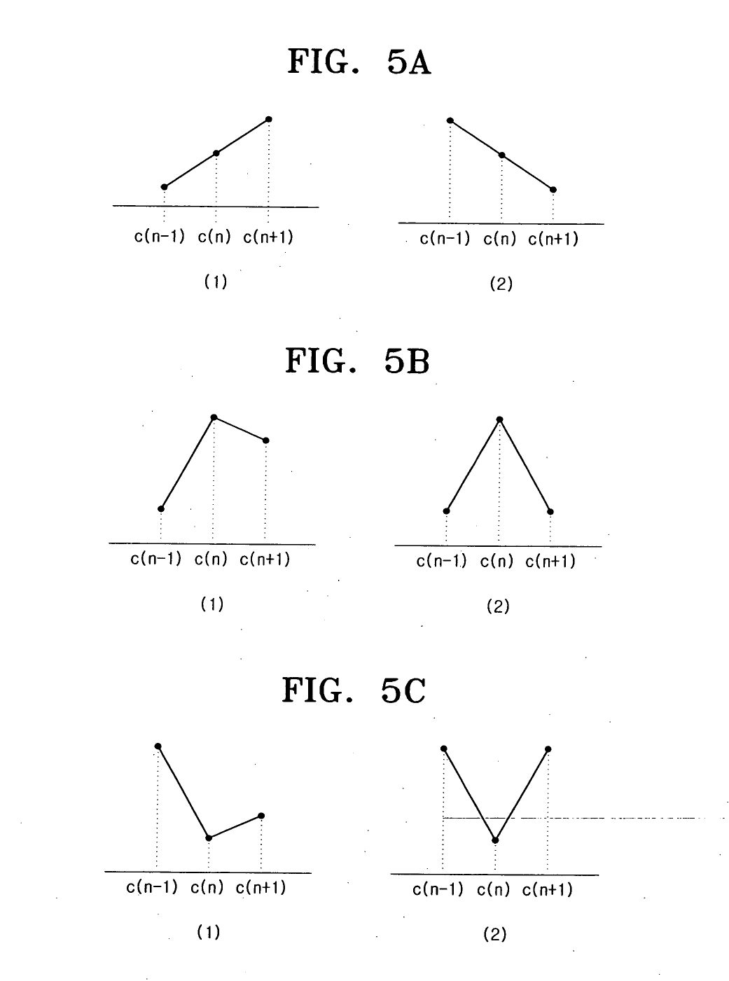

First, the selector 250 compares the pixel value of the current pixel included in the current line of the de-interlaced input image signal, the previous pixel located above the current pixel, and the next pixel located below the current pixel, and judges which one of the three pixel values has as a pixel value among the minimum value, the maximum value, and the median value at operation S440. FIGS. 5A to 5C illustrate examples when the pixel value of the current pixel has the median value, the maximum value, and the minimum value respectively.

As illustrated in examples (1) and (2) of FIG. 5A, when the pixel value of the current pixel c(n) has the median value among the three pixel values at operation S450, the current pixel c(n) corresponds to a middle portion of an edge. When the current pixel c(n) corresponds to the middle portion of the edge, a saw-tooth artifact does not exist, therefore the selector 250 finally outputs the de-interlaced image signal as it is at operation S460, the signal being received from the de-interlacing unit 210.

(1) and 2) of FIG. 5B illustrate examples when the pixel value of the current pixel c(n) is judged to have the maximum value among the three pixel values. That is, if the pixel value of the current pixel is judged to have the maximum value among the pixel values of the three lines at operation S470, the selector 250 compares the diffusion value and the median value received from the diffusion value calculator 230 and the median value calculator 240 respectively, and the greater one of the two values is selected and output at operation S480. This can be represented in a mathematical formula described below.
[Mathematical formula 2]
   Max(Median, Diffusion)

In the mathematical formula 2, Max is a function to calculate a maximum value, Median represents a median value, and Diffusion represents a diffusion value.

First, referring to example (1) of FIG. 5B, the median value is greater than the diffusion value, so that the selector 250 finally outputs the median value. The median value is selected in order to maintain, if possible, the edge shape depicted in example (1) of FIG. 5B.

In addition, referring to example (2) of FIG. 5B, the diffusion value is greater than the median value, so that the selector 250 finally outputs the diffusion value. The diffusion value is output in order to maintain the edge shape of a detailed component having a big difference between the pixel values.

In the same manner, (1) and (2) of FIG. 5C illustrate examples when the pixel value of the current pixel c(n) is judged to have the minimum value among the three pixel values. That is, in a case where the pixel value of the current pixel c(n) is judged to have the minimum value among the three pixel values at operation S490, the selector 250 compares the diffusion value and the median value received from the diffusion value calculator 230 and the median value calculator 240 respectively, and a smaller one of the median value and the diffusion value is output in operation S500. This can be represented in a mathematical formula described below.
Mathematical formula 3]
   Min(Median, Diffusion)

In the mathematical formula 3, Min is a function to calculate a minimum value, Median represents the median value, and Diffusion represents the diffusion value.

Referring to example (1) of FIG. 5C, the median value is smaller than the diffusion value, so that the selector 250 finally selects and outputs the median value. The median value is selected in order to maintain, if possible, the edge shape depicted in example (1) of FIG. 5C.

In addition, referring to example (2) of FIG. 5C, the diffusion value is smaller than the median value, so that the selector 250 finally selects and outputs the diffusion value. The diffusion value is selected in order to maintain, if possible, the edge shape of a detailed component having a big difference between the pixel values.

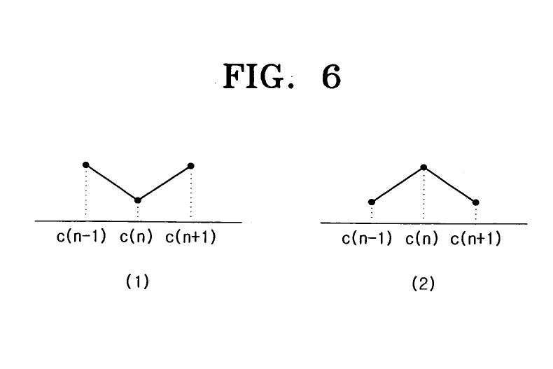

FIG. 6 illustrates examples of neighboring pixels having small pixel differences, for an image signal containing saw-tooth artifacts. Referring to example (1) of FIG. 6, the current pixel c(n) has the minimum value, so that the selector 250 compares the median value and the diffusion value, and outputs the smaller value. In example (1) of FIG. 6, the diffusion value is the smaller value, so that the selector 250 finally outputs the diffusion value.

In addition, referring to example (2) of FIG. 6, the current pixel c(n) has the maximum value, so that the selector 250 compares the median value and the diffusion value, and outputs the greater value. In example (2) of FIG. 6, the diffusion value is the greater value, so that the selector 250 finally outputs the diffusion value.

In this manner, by applying the diffusion value generated by low-pass filtering to the neighboring pixels having a small pixel difference, the saw-tooth artifacts are removed.

As described above, according to the present general inventive concept, the saw-tooth artifacts generated when the neighboring pixels have a small difference can be removed, and, at the same time, the detailed components of an image can be represented effectively without being lost.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. An apparatus to enhance a distinction of image signals, the apparatus comprising:
a de-interlacing unit to de-interlace input image signals using an interlaced scanning method and to output a de-interlaced image signal using a progressive scanning method; and
a saw-tooth artifact processor to remove saw-tooth artifacts based on a diffusion value and a median value of the de-interlaced image signal, the saw-tooth artifacts being included in the de-interlaced image signal.

2. The apparatus as claimed in claim 1, wherein the saw-tooth artifact processor includes:
a diffusion value calculator to calculate the diffusion value based on a similarity of the de-interlaced image signal;
a median value calculator to calculate the median value based on a magnitude of the de-interlaced image signal; and
a selector to compare a pixel value of a current pixel included in a current line of the de-interlaced image signal with pixel values of pixels neighboring the current pixel, and to remove the saw-tooth artifacts by selectively outputting the diffusion value and the median value according to the comparison.

3. The apparatus as claimed in claim 2, wherein the diffusion value calculator judges whether the pixels neighboring the current pixel is similar when a pixel difference of the pixel values of the pixels neighboring the current pixel in the de-interlaced image signal is smaller than a predetermined threshold value, and calculates the diffusion value by performing low-pass filtering on the current pixel and the pixels neighboring the current pixel.

4. The apparatus as claimed in claim 2, wherein, when a pixel difference of the pixel values of the pixels neighboring the current pixel in the de-interlaced image signal is greater than a predetermined threshold value, the diffusion value calculator outputs the de-interlaced image signal received from the de-interlacing unit as is.

5. The apparatus as claimed in, claim 2, wherein the neighbor pixels comprise a previous pixel and a next pixel of a previous line and a next line of the current line respectively, and the median value calculator calculates the median value by comparing the pixel value of the current pixel included in the current line of the de-interlaced image signal with the pixel values of the previous pixel and the next pixel, the previous pixel being included in the previous line and located above the current pixel, the next pixel being included in the next line and located below the current pixel.

6. The apparatus as claimed in claim 2, wherein, when the pixel value of the current pixel is the median value of the pixel values of the pixels neighboring the current pixel, the selector outputs the de-interlaced image signal as is.

7. The apparatus as claimed in claim 2, wherein, when the pixel value of the current pixel is a maximum value of the pixel values of the pixels neighboring the current pixel, the selector outputs a greater one of the diffusion value and the median value received from the diffusion value calculator and the median value calculator, respectively.

8. The apparatus as claimed in claim 2, wherein, when the pixel value of the current pixel is a minimum value of the pixel values of the pixels neighboring the current pixel, the selector outputs a smaller one of the diffusion value and the median value received from the diffusion value calculator and the median value calculator, respectively.

9. A method to enhance an image signal distinction, the method comprising:
de-interlacing input image signals using an interlaced scanning method and outputting de-interlaced image signal using a progressive scanning method; and
processing the saw-tooth artifacts in order to remove the saw-tooth artifacts based on a diffusion value and a median value of the de-interlaced image signal, the saw-tooth artifacts being included in the de-interlaced image signal.

10. The method as claimed in claim 9, wherein the processing of the saw-tooth artifacts comprises:
calculating the diffusion value based on a similarity of the de-interlaced image signal, and calculating the median value based on a magnitude of the de-interlaced image signal; and
comparing a pixel value of a current pixel included in a current line of the de-interlaced image signal with pixel values of pixels neighboring the current pixel, and removing the saw-tooth artifacts by selectively outputting the diffusion value and the median value according to the comparison.

11. The method as claimed in claim 10, wherein, when a pixel difference of the pixels neighboring the current pixel in the de-interlaced image signal is smaller than a predetermined threshold value, the diffusion value is calculated by performing low-pass filtering on the pixels.

12. The method as claimed in claim 10, wherein, the comparing of the pixel value of the current pixel and removing the saw-tooth artifacts, comprises when the pixel value of the current pixel is equal to the median value of the pixels neighboring the current pixel, outputting the de-interlaced image signal as is.

13. The method as claimed in claim 10, wherein, the comparing of the pixel value of the current pixel and removing the saw-tooth artifacts, comprises when the pixel value of the current pixel is equal to a maximum value of the pixels neighboring the current pixel, outputting a greater one of the received median value and the diffusion value.

14. The method as claimed in claim 10, wherein the comparing of the pixel value of the current pixel and removing the saw-tooth artifacts, comprises when the pixel value of the current pixel is a minimum value of the pixels neighboring the current pixel, outputting a smaller one of the received median value and the diffusion value.

15. An apparatus to remove saw-tooth artifacts from a de-interlaced image signal, the apparatus comprising:
a calculating unit to calculate a diffusion value and a median value using a pixel value of a current pixel, and pixel values of pixels neighboring the current pixel; and
a selector to output one of the pixel value of the current pixel, the diffusion value and the median value according to a first comparison of the pixel value of the current pixel with the pixel values of the pixels neighboring the current pixel, and a second comparison of the diffusion value and the median value.

16. The apparatus as claimed in claim 15, wherein the calculating unit outputs as the diffusion value the pixel value of the current pixel when a difference of the pixel values of the pixels neighboring the current pixel is smaller than a predetermined value.

17. The apparatus as claimed in claim 15, wherein the plurality of pixels values of the de-interlaced image signal form lines, and the current pixel is included in a current line, and the pixels neighboring the current pixel are a previous pixel included in a previous line and a next pixel included in a next line respectively.

18. The apparatus as claimed in claim 17, wherein the previous line is above the current line and the next line is bellow the current line, and the calculating unit calculates the median value using pixel values in the previous line, the current line and the next line.

19. The apparatus as claimed in claim 15, wherein the selector outputs the pixel value of the current pixel when the pixel value of the current pixel is substantially equal to the median value.

20. The apparatus as claimed in claim 15, wherein the selector outputs a greater one of the diffusion value and the median value, when the pixel value of the current pixel is greater than the pixel values of the pixels neighboring the current pixel.

21. The apparatus as claimed in claim 15, wherein the selector outputs a smaller one of the diffusion value and the median value, when the pixel value of the current pixel is smaller than the pixel values of the pixels neighboring the current pixel.

22. The apparatus as claimed in claim 15, comprising:
a video signal converting unit to convert an interlaced video signal into a progressively scanned video signal including saw-tooth artifacts.

23. A method of removing saw-tooth artifacts from a de-interlaced image signal including a plurality of pixel values, the method comprising:
calculating a diffusion value and a median value using a pixel value of a current pixel, and pixel values of pixels neighboring the current pixel; and
outputting one of the pixel value of the current pixel, the diffusion value and the median value according to a first comparison of the pixel value of the current pixel with the pixel values of the pixels neighboring the current pixel, and a second comparison of the diffusion value and the median value.
